(19) United States
(12) Patent Application Publication
(10) Pub. No.: US 2011/0000564 A1
(43) Pub. Date: Jan. 6, 2011

(54) DUAL PURPOSE MIXER TAP

(75) Inventors: Jean-Yves Corbin, Thaon (FR); Mathias D'estais, Caen (FR)

Correspondence Address: OSHA LIANG L.L.P., TWO HOUSTON CENTER, 909 FANNIN, SUITE 3500, HOUSTON, TX, 77010, US

(73) Assignee: CAPITAL INNOVATION (SARL), St. Ouen Cedex (FR)

(21) Appl. No.: 12/811,844

(22) PCT Filed: Jan. 7, 2009
(86) PCT No.: PCT/FR2009/000007

§ 371 Date: Sep. 20, 2010

(30) Foreign Application Priority Data
Jan. 8, 2008 (FR) 08/50087

(51) Int. Cl. F16K 11/08

(52) U.S. Cl. 137/625.4

(57) ABSTRACT

The present invention relates to a mixer tap for discharging a mixture of liquids, comprising a moving plate mixing system (18) provided with a mixing channel (22), moving in translation on a fixed plate (19) provided with orifices for the inlet of liquids and the outlet of the mixture of said liquids after passing through the mixing channel, characterised in that it comprises a lever (15) angularly orientable in a plane between an angular minimum and a maximum, to vary the flow of the mixture, the lever being capable of pivoting, at constant angular orientation, around one direction of the plane, forming an axis of rotation for a moving cylinder (0) in a fixed tap body, the cylinder being linked to the lever in this movement, to vary the liquid content of the mixture, in that it comprises first means of discharging the mixture, by orienting the lever on one side of a stop position, on the one hand, and stopping the flow of mixture by orienting the lever in a vicinity of the stop position, on the other hand, in that it comprises second means of discharging the mixture by orienting the lever on the other side of the stop position, under the effect of pressure by a user, and in that it comprises a dynamic stop felt by the user when the lever passes through the stop position.

The present invention relates to a dual purpose mixer tap such as, for example, a hot and cold water mixer tap, which can be used as a normal permanent flow mixer tap and as an automatic shut-off mixer tap to save water.

### STATE OF THE PRIOR ART

Mixer taps are known from the prior art that have a complex mixing system, either with a moving plate between two fixed plates, the field of US patent U.S. Pat. No. 4,960,154 of the inventor Diagantis, or with a moving plate on a fixed plate, the field of the present invention. These taps are guided by a lever angularly orientable in a plane between a minimum and a maximum to adjust the flow or to discharge a mixture of liquids and are capable of pivoting, at constant angular orientation, around an axis, generally vertical, situated in said plane, to vary the liquid content of the discharged liquid.

Thus, in the field of mixer taps, lever taps exist enabling a precise adjustment and with generally little effort by the user of the flow of liquid delivered by the tap, by means of the angular orientation of the lever over a range of angles corresponding to the travel of the lever, between an angular stop position where the flow is nonexistent and an end of travel position where the flow is maximum. These taps are adapted to delivering liquid over a long or even unlimited period, requiring a first gesture by the user to initiate the flow of liquid by raising the lever and a second gesture to stop the flow by returning the lever to the stop position.

Push button taps also exist enabling a saving of liquid by limiting the duration of the supply of liquid to the time the push button is held down or the time defined by a temporisation system activated by the push button. When pressed down by a user, the liquid is delivered. When no longer pressed down, the tap is returned to a nonexistent flow by a shut-off system using the energy stored by the user in the push button while pressing down on it or an external energy enabling the shut-off of a valve in the tap. Typically, the push button may comprise a spring return system or a solenoid valve. These taps only require a single gesture by the user, generally a pressing down or a pushing in of the push button, to open the tap, the shut-off being automatic at the end of a finite time. They require a significant effort by the user to store up the energy in the push button when the push button is mechanical.

### PROBLEM OF SOLUTIONS OF THE PRIOR ART

The mechanical configuration of these taps of the prior art and the resulting movements leave little place for the addition of new functions compatible with the operation of the mixer, both in technical terms and in ergonomic terms.

These two types of taps are incompatible and the addition of a push button system to a lever tap, which would return said lever automatically to the stop position when not pressed by the user would be of limited use, since flow of long duration would be impossible on such a tap (an example of this nevertheless being patent N° DE19923988). This association would nevertheless be desirable in order to enable a user, who wishes to economise the amount of liquid delivered by a lever tap for operations that allow the user to moisten his or her hands with water before applying soap to them, to have this possibility.

The juxtaposition on a same mixer tap of an active stop return system on the travel of the lever of the tap and inciting it to return it to the stop position thus does not make it possible to maintain the function of long duration flow lever.

### SOLUTION PROVIDED BY THE INVENTION

The aim of the present invention is to overcome these drawbacks of mixer taps of the prior art by proposing a solution combining the advantages of a lever system and a push button system.

In this context, the invention relates to, according to the claim in its most general acceptation, a mixer tap for discharging a mixture of liquids, comprising a moving plate mixing system provided with a mixing channel, moving in translation on a fixed plate provided with orifices for the inlet of liquids and the outlet of the mixture of said liquids after passing through the mixing channel, which comprises a lever angularly orientable in a plane between an angular minimum and a maximum, to vary the flow of the mixture, the lever being capable of pivoting, at constant angular orientation, around one direction of the plane, forming an axis of rotation for a moving cylinder in a fixed tap body, the cylinder being linked to the lever in this movement, to vary the liquid content of the mixture, which comprises first means of discharging the mixture, by orienting the lever on one side of a stop position, on the one hand, and to stop the flow of mixture by orienting the lever in a vicinity of the stop position, on the other hand, which comprises second means of discharging the mixture by orienting the lever on the other side of the stop position, and which comprises a dynamic stop felt by a user pressing on the lever, when the lever passes through the stop position.

Advantageously, the dynamic stop comprises means of returning the lever to the vicinity of the stop position, when not pressed by the user, for positions of the lever beyond the stop position, said return means being inactive during the positioning of the lever before stop position, while moving away from said stop position.

According to a first alternative, said first means are suited to enabling, by orienting the lever on one side of the stop position, the rotation in one direction of an intermediate part, linking said lever to said moving plate, to control said translation of the moving plate on said fixed plate, the translation controlling said flow of mixture, and the second means are suited to enabling, by orienting the lever on the other side of the stop position, the orientation of the intermediate part in the same said direction.

According to a second alternative, the first means comprise, in said plate moving in translation on said fixed plate, a first hollow channel enabling the flow of mixture for orientations of said lever on one side of the stop position, and a solid zone to stop the flow of mixture at the stop position, and the second means comprise, in said plate moving in translation on said fixed plate, a second hollow channel, connected to the first channel, enabling the flow of mixture for orientations on the other side of the stop position.

According to a third alternative, the first means comprise a first liquid circuit comprising a first liquid inlet pipe and a second liquid mixture outlet pipe, the flow of mixture between the pipes being controlled by the orientation of the lever on one side of the stop position and stopped at this position, the second means comprise a second liquid circuit comprising a first liquid inlet tube and a second liquid mixture outlet tube, the flow between the tubes being controlled by the orientation of the lever on the other side of the stop position, controlling a solenoid valve separating the first and the second tube, and the second pipe and the second tube are connected together.

According to a fourth alternative, the first means comprise in the moving plate a groove to receive a pin integral with the lever, the lever being movable in rotation around an axis, the displacement of the pin in the groove controlling the translation of the plate in one direction and the flow of mixture for orientations of the lever on one side of the stop position, and stopping said flow at the stop position, and the second means comprise an extension of the groove to conserve the same said direction of translation of the moving plate by orientation of the lever on the other side of the stop position.

According to a fifth alternative, the first means comprise a gear assembly common to the intermediate part and to the lever, orienting the intermediate part in rotation in one direction when the lever is oriented on one side of the stop position and the second means are constituted of a flat spot common to the intermediate part and to the lever, orienting the intermediate part in rotation in the same said direction when the lever is oriented on the other side of the stop position, the lever being movable around a first axis, the intermediate part being movable around a second axis and the first axis being displaced by guiding means on a circular trajectory centred on the second axis for orientations of the lever on the other side of the stop position.

According to a specific embodiment, the first means comprise a groove in the intermediate part to receive a pin integral with the lever, the lever being movable in rotation around a first axis and the intermediate part around a second axis, the displacement of the pin in the groove inducing the rotation of the intermediate part in one direction, when the lever is oriented on one side of the stop position and the second means comprise an extension of the groove in the intermediate part, the displacement of the pin inducing the rotation of the intermediate part in the same said direction, when the lever is oriented on the other side of the stop position

According to a second specific embodiment, the first and the second means comprise a connecting rod linking the lever and the intermediate part, the connecting rod being movable in a primary axis of rotation around the lever and in a secondary axis around the intermediate part, the lever being movable in rotation around a first axis and the intermediate part around a second axis, the axes being parallel to each other, the stop position being defined by the orthogonality of the plane of the primary and secondary axes and the plane of the secondary and second axes, the rotation of the intermediate part taking place, by means of the connecting rod, in a same direction for an orientation of the lever on one side and on the other side of the stop position.

According to a third specific embodiment, the first means comprise a first axis for the rotation of the intermediate part, comprise a circular groove, formed in the lever and centred on said first axis, comprise a pin integral with said cylinder, arranged in the groove, said pin bearing on a first end of the groove at the stop position of the lever and beyond, and the pin being displaced in the groove for positions of the lever on one side of said stop position, to assure an orientation of the lever in rotation around the first axis on one side of the stop position and around the pin on the other side, and comprise a first blocking lug, formed in the lever, immobilising the intermediate part in relation to the lever for its positions on one side of the stop position, when the lever is moved away from said stop position, to induce the rotation of the intermediate part in one direction, the second means comprise a second lug, formed on the lever, arranged between the first axis and the pin, the rotation of the lever around the pin in the opposite direction for orientations of the lever on the other side of the stop position controlling the rotation of the intermediate part in the same said direction, by said second lug bearing on this intermediate part, and the return means are arranged between the intermediate part and the lever.

According to other specific alternatives:

1) the second channel is entirely in the moving part,

2) the second channel is entirely in the fixed part,

3) the second channel is partly in the moving part and partly in the fixed part,

4) the first and the second liquid circuits comprise a common liquid inlet pipe,

5) the first and the second liquid circuits each comprise its own liquid inlet pipe,

6) the return means are a spring arranged between said lever and said cylinder, linked to only one of these two components, and operating in compression on the other side of the stop position,

7) the return means are a spring associated with a temporisation system slowing down the return of the lever in the vicinity of the stop position,

8) the dynamic stop is active to deliver a signal to the user in an immediate vicinity of the stop position,

9) the dynamic stop comprises a first lever return means, active on one side of the stop position and a second lever return means active on the other side of the stop position,

10) the signal is visual, acoustic or tactile,

11) the first return means are a first spring and the second return means are a second spring,

12) the first means make it possible to obtain the flow of liquids between first liquid inlets and a first mixture outlet and the second means make it possible to obtain the flow of liquids between second liquid inlets and a second mixture outlet,

13) the first means make it possible to obtain the flow of liquids between first liquid inlets and a first mixture outlet and the second means make it possible to obtain the flow of liquids between said first liquid inlets and a second mixture outlet,

14) the first means make it possible to obtain the flow of liquids between first liquid inlets and a first mixture outlet and wherein the second means make it possible to obtain the flow of liquids between second liquid inlets and said first mixture outlet.

The invention further relates to the production of a lever mixer tap provided with additional liquid flow means, without changing the amplitude of the travel of the lever.

### DESCRIPTION OF FIGURES

The invention will be better understood on reading the description that follows, relating to non-limiting embodiments of the invention, and by referring to the appended drawings, in which:

FIG. 1 represents in section a tap according to a first embodiment of the invention provided with an intermediate part, a gear assembly and a flat spot,

FIGS. 2 to 7 represent in section a tap according to the embodiments of the invention, from the second to the seventh,

FIGS. 8, 9 and 10 represent three alternatives of the second embodiment for the layout of the moving and fixed parts of said embodiment,

FIG. 11 represents the invention with a ball ratchet type intermediate stop,

FIG. 12 represents the invention with a double spring type intermediate stop,

FIG. 13 represents a version with intermediate stop and two separate channels for two liquid flow modes.

To make the drawings easier to read, only one water inlet pipe in the axis of the body of the mixer itself has been represented. It goes without saying they concern mixers and thus that there is a dual water inlet, typically cold water and hot water.

Those skilled in the art will thus understand in the light of the description that follows that a liquid circuit situated in the plane of a figure may comprise, outside of said plane, another inlet for another liquid to be mixed in said circuit and that the dimension outside of said plane of the components of said circuit may have to be adapted to enable the introduction of this other liquid in said circuit in order to assure the mixer function of the tap represented.

Likewise, those skilled in the art will understand from the description that certain components, although they cannot be recalled in detail for all embodiments of the invention, are common to lever mixer taps and thus present for all of these embodiments.

It relates in particular to the moving ceramic plate mixing system provided with a mixing channel, moving in translation on a fixed ceramic plate provided with orifices for the inlet of liquids and the outlet of the mixture of said liquids after passing through the mixing channel.

It also relates to a device to render the function of adjustment of the mixture independent of the adjustment of the flow in the tap, allowing the rotation around an axis, usually vertical, of the lever and all the moving parts making it possible to adjust the flow of the mixer, up to the moving plate of the mixing system. In the following description, this device will take the form of a cylinder that can pivot in the body of the tap around a vertical axis, supporting the axes of rotation of the lever and all of the turning parts in the tap and driving in rotation the moving plate to assure a variable covering of the liquid inlets of the fixed plate by the inlet of the channel of this moving plate and to make it possible to adjust the mixture by rotation. A lever mixer tap to which the invention applies may therefore, from this point of view, be divided into a first sub-assembly of moving parts, integral with the cylinder, and a second sub-assembly of fixed parts, integral with the body of the tap.

### DESCRIPTION OF THE INVENTION

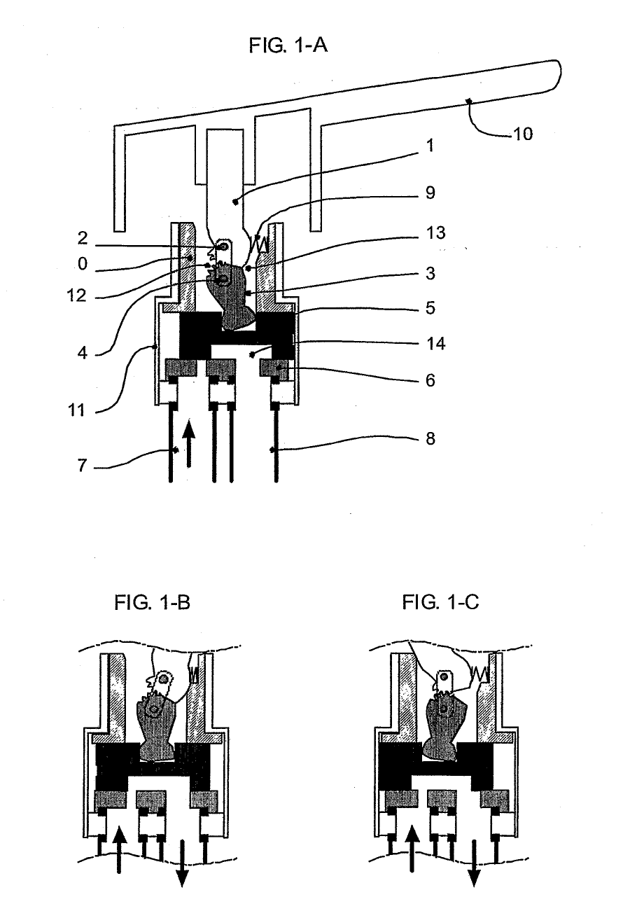

The invention is described in a first embodiment (FIG. 1) as a tap comprising in a cylinder (0), a lever (1), comprising a handle (10), moving in rotation around a first axis (2), comprising an intermediate part (3) moving in rotation around a second axis (4) one of the ends of which is in contact with the lever (1) the other end being inserted in a moving plate (5) on a fixed plate (6) assembled in a tap body (11), the fixed plate comprising at least one water inlet pipe (7) and a water outlet pipe (8), the tap comprising a spring (9) integral with the cylinder (0) or integral with the lever (1), the contact surface between the lever (1) and the intermediate part (3) being provided with a gear assembly (12) and a flat spot (13) and the moving plate (5) being provided with a cavity (14) and a solid zone.

In the position of FIG. 1, the tap is in stop position and the flow is nonexistent. The spring (9) just opposes the orientation of the lever (1) in the indirect direction on the other side of the stop position and this opposition is effectively felt by the user as a stop. The spring (9) is not linked to the lever (1) for orientations in the direct direction on one side of the stop position, it is compressed on the other side of the stop position on the cylinder (0) by the lever.

When the handle (10) is raised by a user, on one side of the stop position, the end of the handle moving away from the water pipes, the lever (1) undergoes a rotation around the first axis (2) in the direct direction and the gear assembly (12) assures the rotation of the intermediate part (3) in the indirect direction around the second axis (4). This rotation drives in translation towards the left the moving plate (5) above the fixed plate (6) and the cavity (14) in the moving plate (5), partially covering the water inlet pipe (7), then forms a channel for the passage of the liquid between the water inlet pipe (7) and the outlet pipe (8) via the cavity (14), controlling a flow of liquid.

When the handle (10) is lowered by a user, beyond the stop position, the end of the handle approaching the water pipes, the lever (1) is blocked in rotation around the first axis (2) in the indirect direction thanks to the flat spot (13) and carries out the rotation of the intermediate part (3) in the indirect direction around the second axis (4). This rotation drives in translation towards the left the moving plate (5) above the fixed plate (6) and the cavity (14) in the moving plate (5), partially covering the water inlet pipe (7), then forms a channel for the passage of the liquid between the water inlet pipe (7) and the outlet pipe (8) via the cavity (14). The spring (9) is integral with the lever (1) in this movement on the other side of the stop and the user senses a resistance. When the user releases his or her pressure on the lever (1), the spring (9) pushes the lever up to the stop position. In orientations of the lever on the other side of the stop position, the first axis (2) describes a circular movement around the second axis (4) in an arc of circle shape guiding groove centred on the second axis and making it possible to maintain the first axis parallel to the second in the movement of the first axis around the second, the guiding groove blocking the rotation of the first axis in relation to the second, on one side of the stop position. A connecting rod may also be used as alternative to the guiding groove, for the same purposes as the groove.

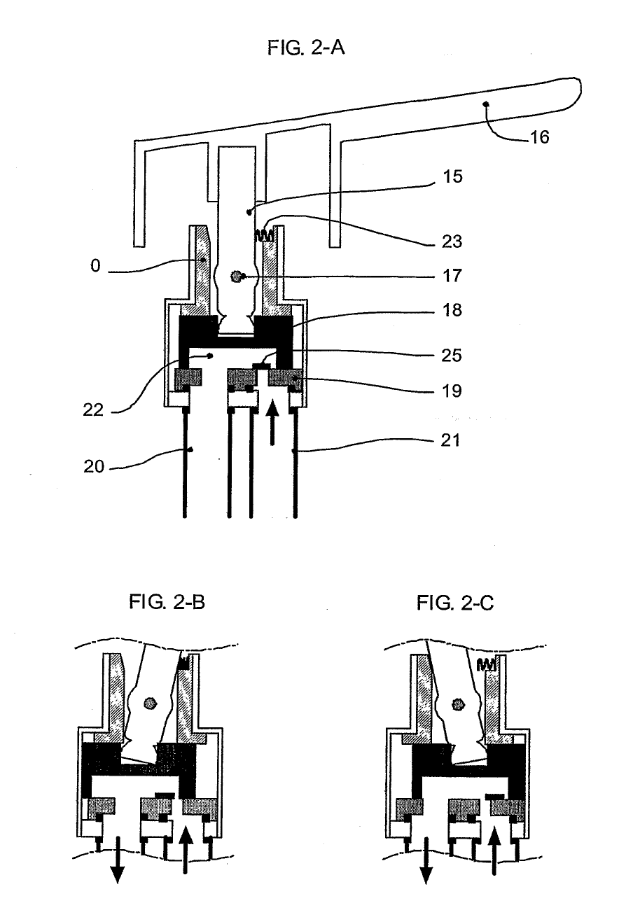

The invention is described in a second embodiment (FIG. 2) as a tap comprising in a cylinder (0), a lever (15), comprising a handle (16), the lever being orientable in rotation around an axis (17) and having one end inserted in a moving plate (18) surmounting a fixed plate (19) integral with at least one water inlet pipe (21) and a water outlet pipe (20). The moving plate comprises a hollow channel (22) composed of first and second orifices linked by a channel situated in the moving part (18) and separated by a solid zone (25). A spring (23) is used for the same purposes as in the first embodiment to form a stop.

In the figure, the hollow channel (22) has one of its orifices facing the liquid outlet pipe (20), its solid zone (25) sealing the liquid inlet pipe (21), no flow of liquid is delivered by the tap and said tap is in the stop position. For a variation in orientation in the direct direction, on one side of the stop, the first orifice covers at least partially the two pipes and a flow of liquid is established. For a variation in orientation in the indirect direction, on the other side of the stop, the second orifice partially covers the inlet pipe (21) and a flow of liquid is established between the pipes (20, 21) via the hollow channel (22) joining the two orifices.

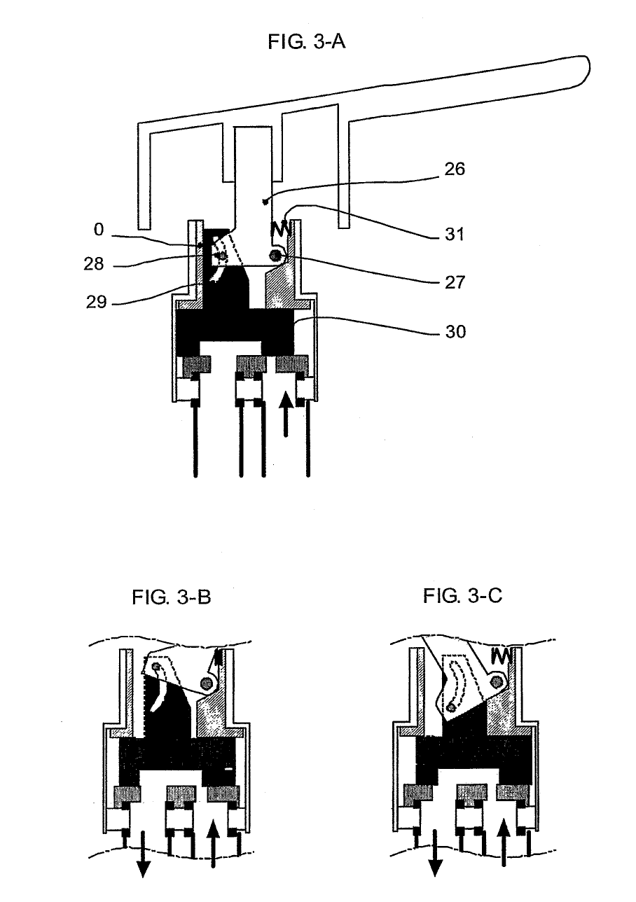

The invention is described in a third embodiment (FIG. 3) as a tap comprising a lever (26), the lever being orientable in rotation around an axis (27) and having a pin (28) inserted in a groove (29) of a plate (30) moving in translation to control a flow of liquid in the tap. A spring (31) is used for the same purposes as in the first embodiment to form a stop for the lever (26).

In this embodiment, the arc of circle shape of the groove (29) having a convex face to the axis of rotation (27) makes it possible, when the pin (28) is rotated in the direct or indirect direction, to induce the translation of the moving plate (30) in the same direction and to induce a flow of liquid in the tap for orientations of the lever on one side or the other of the stop position where the spring (31) is just compressed by the lever (26).

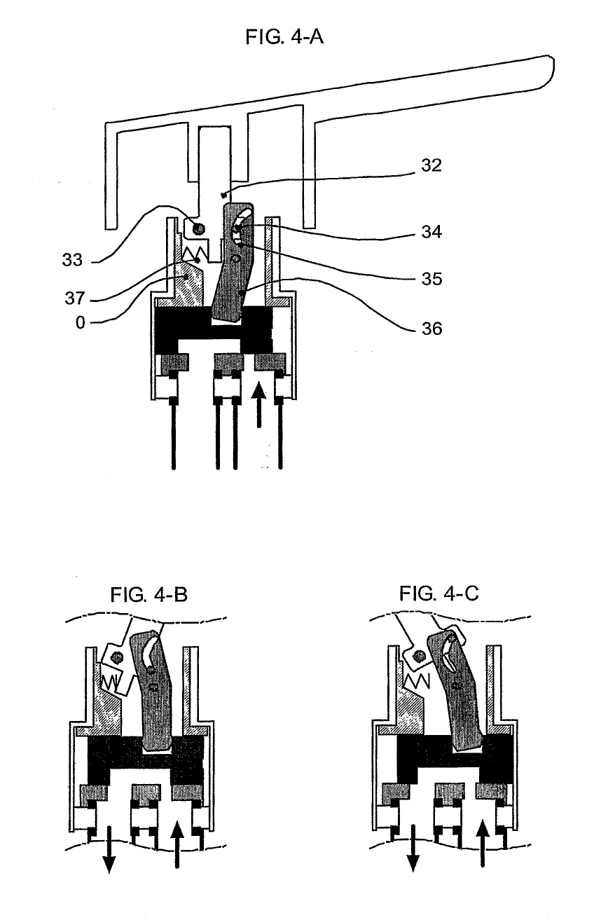

The invention is described in a fourth embodiment (FIG. 4) as a tap comprising in a cylinder (0), a lever (32), the lever being orientable in rotation around an axis (33) and having a pin (34) inserted in a groove (35) of an intermediate part (36) to control a flow of liquid under the same conditions as in the first embodiment. A spring (37) is used for the same purposes as in the first embodiment to form a stop for the lever (32).

In this embodiment, the arc of circle shape of the groove (35) having a convex face to the axis of rotation (33) makes it possible, when the pin (34) is rotated in the direct or indirect direction, to induce the rotation of the intermediate part (36) in the same direction, indirect in the figure, and to induce a flow of liquid in the tap for orientations of the lever on one side or the other of the stop position where the spring (37) is just compressed by the lever (32).

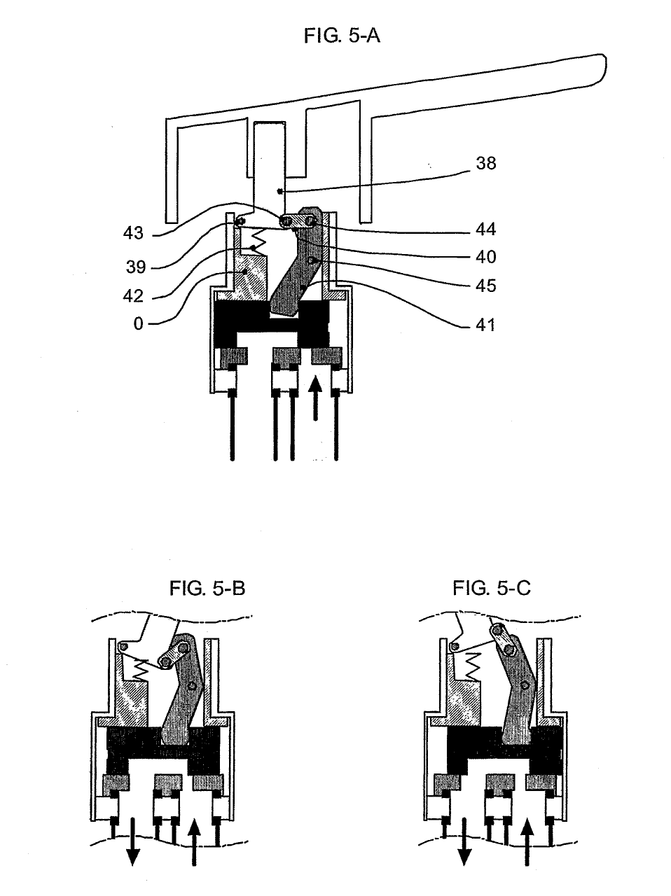

The invention is described in a fifth embodiment (FIG. 5) as a tap comprising in a cylinder (0), a lever (38), the lever being orientable in rotation around a first axis (39) and linked by a connecting rod (40) to an intermediate part (41) moving in rotation around a second axis (45) to control a flow of liquid under the same conditions as in the first embodiment. A spring (42) is used for the same purposes as in the first embodiment to form a stop for the lever (38).

In this embodiment, the connecting rod (40), as rigid shaft connected to the lever by a first axis of rotation (43) and to the intermediate part (41) by a second axis of rotation (44), makes it possible for orientations of the lever on one side or the other of the stop position, in which the spring (42) is just compressed by the lever (38), to obtain a translation in the same direction, of the intermediate part, to control a flow of liquid in the tap.

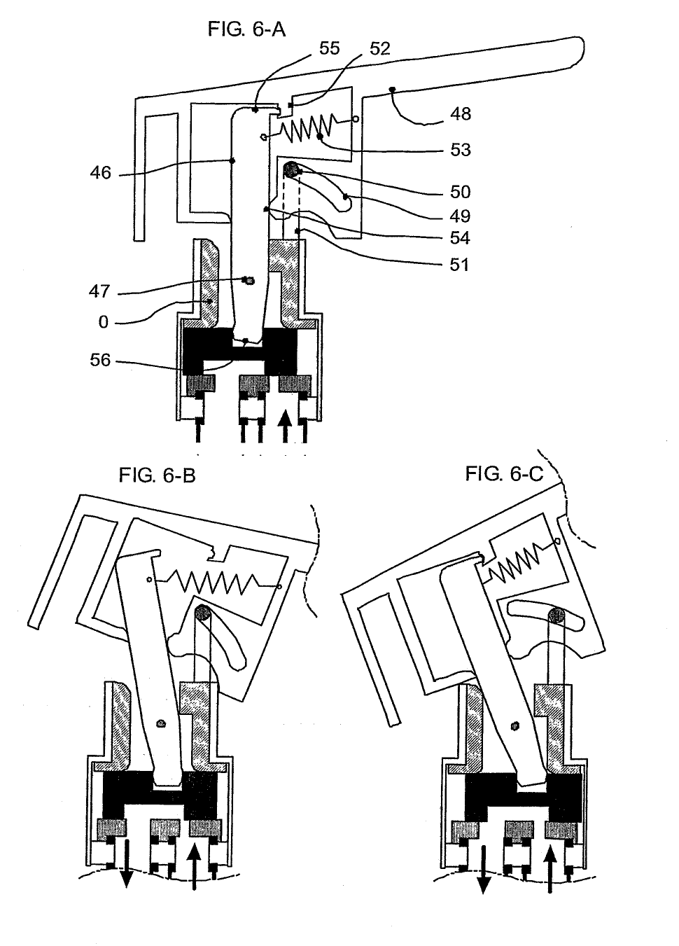

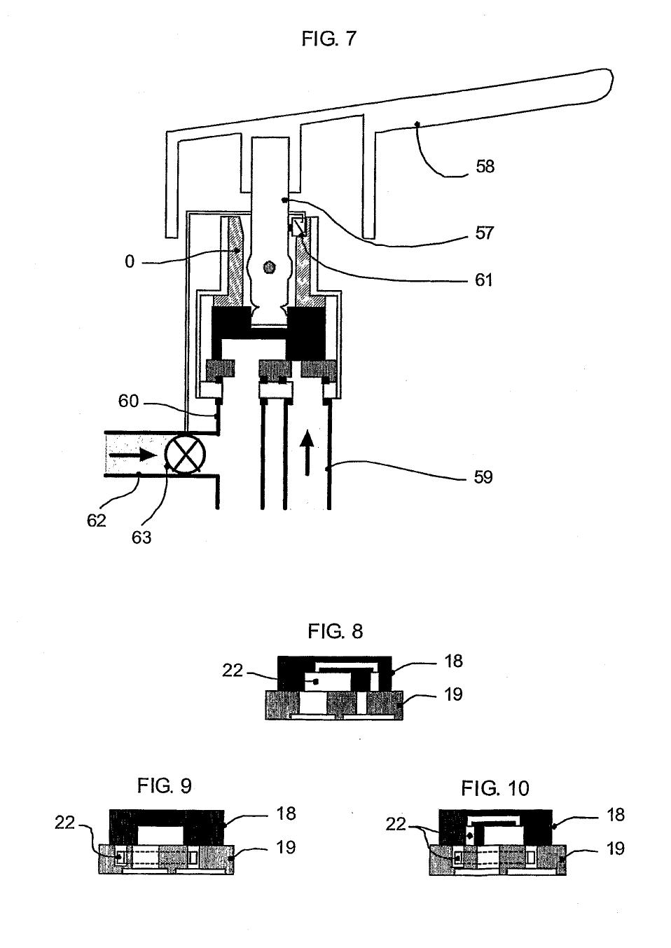

The invention is described in a sixth embodiment (FIG. 6) as a tap comprising in a cylinder (0), a lever (46), the lever being orientable in rotation around a first axis (47) and a handle (48) provided with a groove (49) for the guiding of a second axis of rotation (50) integral with the cylinder (0), the handle being provided with an interior stop (52) for a first end of the lever (55), the second end of the lever (56) being inserted in a moving plate to control the flow of liquid in similar conditions to the first embodiment and the handle further comprising a pin in permanent contact (54) with the lever, situated between the second axis of rotation (50) and the first axis of rotation (47). A spring (53), integral with the handle (48) and the lever (46), is used to return the lever (46) to the stop position, bearing on the stop (52).

The tap being closed and in the stop position, the flow of liquid being nonexistent in the tap, the first end of the lever (55) is bearing on the stop (52) thanks to the spring (53) and the second axis (50) is bearing on one of the ends of the groove (49) or start of the groove.

In this stop position, a variation in the orientation of the handle in the direct direction, on one side of the stop position imposes at the first end of the lever (55), bearing on the stop (52), a variation in orientation in the same direct direction, the second axis of rotation (50) progressing in the groove (49) up to its end, a flow of liquid is then delivered by the tap. When the handle returns towards the stop position, the spring (53) maintains the lever on the stop and returns it with the handle, the second axis regressing into the groove until returning to bear on the start of groove.

A variation in the orientation of the handle in the indirect direction, on the other side of the stop position, then imposes on the lever a thrust at the permanent point of contact (54) of the handle in rotation around the second axis (50) bearing on the start of the groove (49). This thrust imposes an extension of the spring (53), a detachment of the first end of the lever (55) from the stop (52) and a variation in orientation in the direct direction of the lever (46) around the first axis (47), establishing a flow of liquid in the tap. When pressure ceases on the handle, on the other side of the stop position, the spring (53) incites the return of the whole of the tap to its stop position.

In a seventh embodiment, the invention is constituted by a tap comprising in a cylinder (0), a lever (57) provided with a handle (58), the lever controlling a flow of liquid between a first water circuit established between at least one inlet pipe (59) and a second liquid outlet pipe (60), the lever closing a switch (61) playing the role of stop for variations in the orientation of the lever in the indirect direction. A second water or other liquid circuit is established between a third liquid inlet pipe or tube (62) separated from the liquid outlet pipe by a solenoid valve (63), when the solenoid valve is controlled by the closing of the switch (61) following pressure on the lever to incite it to take orientations on the other side of the stop position.

In alternatives of the second embodiment of the invention, the moving part (18) and the fixed part (19) may be used alternatively or jointly to form the hollow channel (22).

In the first alternative (FIG. 8), already described (FIG. 2), the channel is situated entirely in the moving part (18).

In a second alternative (FIG. 9), the channel is situated entirely in the fixed part (19).

In a third alternative (FIG. 10), the channel is situated partly in the moving part (18) and partly in the fixed part (19).

Concerning the sixth embodiment of the invention, it is possible to observe that the spring (53), linked to the handle and to the lever, which returns the lever towards the stop position on the other side of this stop position, working in traction, is inactive in its function of returning the lever to the stop position, even if it may be subjected to a slight tension to lay flat the lever on the lug (52), during a positioning of the lever on one side of the stop position, in other words during the displacement of the lever to attain a position of the lever situated on one side of the stop position, while moving away from the stop position, this corresponding a priori to a permanent flow of liquid lasting indefinitely. Said spring is however active in traction, during the repositioning of the lever towards the stop position from a position situated on one side of this stop position. The layout of the spring on the other side of the lever would make it possible to link only said spring to the handle, for an equivalent operation, the spring being inactive in compression, even if it may be subjected to a slight compression to lay flat the lever on the lug (52) only during the positioning of the lever towards a position on one side of the stop position, while moving away from this stop position.

In all of the embodiments, other locations of the spring may exist since all the mechanical movements are linked together. Thus, introducing a leaf spring between the moving disc and the body of the mixer could be imagined.

A dampened spring could also be used, for example a gas piston in which the calibrated leakage makes it possible to control the return rate of the spring incorporated in the piston.

Concerning the general inventive concept of the invention, it is possible to observe that the combination of a push button tap and a lever tap is not the only teaching of the invention. The push button tap is used as tap enabling the saving of liquid or even as second liquid flow mode in a lever tap only comprising, without the invention, a first liquid flow mode. The invention also thus relates to a method that makes it possible to integrate in one lever tap, means suited to be used to save liquid, or to make available to the user a second operating mode of the tap accessible without changing the amplitude of the travel of the lever.

From this point of view, the invention is also a method that makes it possible to integrate two liquid flow operating modes, in a lever tap without changing the angular travel of the lever of said tap.

This method is characterised in that it consists in:
separating the travel of the lever of a tap mixer, variable in angular position between a minimum and a maximum, into two angular ranges, by an intermediate stop, active to deliver a signal to a user of the lever, when said lever passes through an angular stop position, intermediate between the minimum and the maximum,
modifying means associating the angular position of the lever to the flow of liquid in the tap, to obtain a stable nonexistent flow of a mixture of liquids discharged by the tap, at the intermediate position, to obtain a first liquid flow mode between the intermediate position and the angular maximum of the lever, and to obtain a second liquid flow mode between the intermediate position and the angular minimum of the lever.

It may thus be considered that a lever mixer tap having a dynamic stop, capable of producing a signal perceptible by the user when the lever passes through an intermediate, stop position, and in which the liquid mixture flow means are split into two liquid flow modes for positions of the lever on either side of the intermediate position complies with the teaching of the invention.

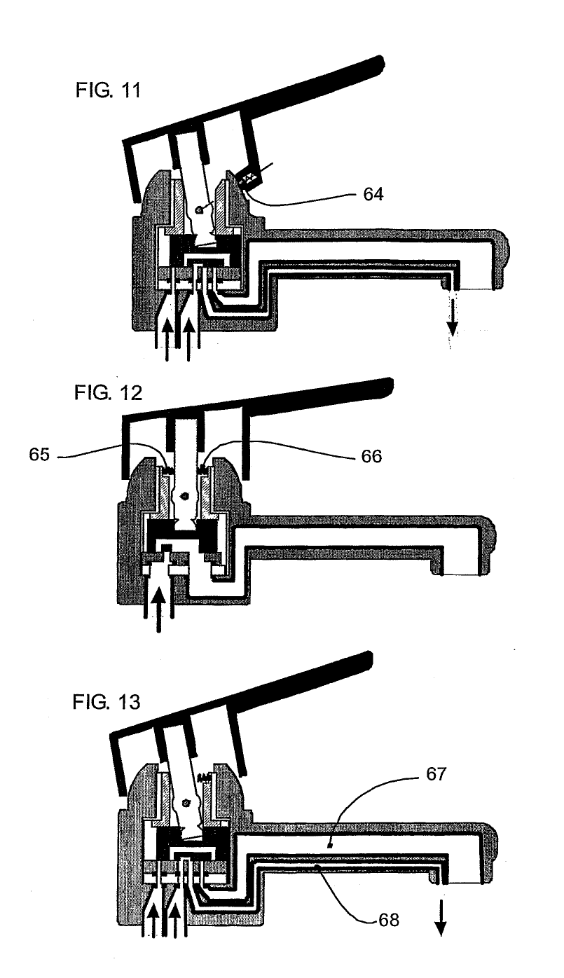

A visual signal could thus be envisaged such as that of a light emitting diode or an audible beep or finally (FIG. 11) a mechanical ratchet (64) caused by the entry of a ball contained in a cavity arranged in the handle of the lever of the tap and pushed by a spring, the entry taking place in a cavity arranged in the body of the tap. The user may in this latter case be informed in a tactile manner, by a jolt at the arrival at the intermediate stop, a transition in the force to be provided to move the lever being felt on arriving at the intermediate position, in its immediate vicinity, when the ball comes out of the handle.

It is also possible to carry out the teaching of the invention (FIG. 12) by compressing a spring between the lever and the cylinder (0) of a lever tap, the spring being attached to a single one of these components, or instead in an equivalent manner, by arranging two separate springs (65) (66), one being compressed during a positioning of the lever towards the angular values beyond the intermediate position and the other being compressed for a positioning towards the values before the intermediate position. In the case of two springs, the two springs may each be attached to the lever and to the cylinder (0) or only to a single one of these components. A zero or low force is then felt by the user when the lever passes through the intermediate position. The springs act as means of return to this position for non-intermediate positions of the lever. In these cases, there exists no real, static stop located at the stop position but only a dynamic stop, which is felt by the hand of the user on account of the absence of the specific or intrinsic return phenomenon of the lever, in other words felt “as a slack” on passing through the stop position.

Likewise, the means associating the angular position of the lever with the flow of liquids could be modified in order to enable a first flow of liquids in a first channel of a mixer mixing plate, moving on a fixed plate beyond the intermediate position or stop and a second flow of liquids in a second channel before this position.

The formation (FIG. 13) of two non-communicating channels (67) (68) in a mixer plate instead of communicating channels, could be carried out for this purpose. Forming a single tap to deliver two mixtures of different liquids is thus possible with the invention.

It will also be possible with a moving plate in a tap mixer, provided with two channels communicating as described previously, to chose either to deliver the liquid according to two modes sharing an inlet or an outlet, so as to distribute the liquid for example between a shower and a bath tap if the outlet is separate and the inlet shared or a mixture of two products such as mains water and filtered water if the outlet is shared and the inlets separate. Two channels completely separate or sharing either the mixture outlet or the liquid inlets may thus be used according to the invention to conceive dual purpose mixers.

The dynamic stop according to the invention may thus be envisaged in several forms below.

A dynamic stop, uniquely activated when the lever has left the intermediate position and capable of inducing a clean stop when the lever meets it in intermediate position, said clean stop is then eclipsed to leave free any new displacement of the lever. Such a stop may be formed by a part similar to an anchor escapement used in timepiece making.

A dynamic stop may also be formed by a magnet passing near to a ferrous material when the intermediate position is approached. This magnet may for example be fixed to a part of the handle, pro-eminent towards the interior, which passes in contact with the body of the tap formed for its part in ferrous material, when the intermediate position is approached.

A dynamic stop is more generally a change in perception by the user who manipulates the handle of the mixer in a VERTICAL plane between an angular minimum and a maximum and passes near to the angular value for which the flow of liquid is interrupted. Thus, a change in the return of force of the lever on the hand of the user due to the presence of a spring, the compression of which starts from orientation values on one side of and/or on the other side of the angular value for which the flow of liquid is interrupted is a dynamic stop according to the patent. Likewise, it is possible, according to the patent, to fulfil a conception that minimises the friction during displacements on one side of the stop and which generates a non-negligible friction for displacements on one side of the stop.

These systems may be used individually or jointly. For instance, a dynamic stop as described in FIG. 11 of mechanical ball ratchet type may be advantageously combined with a dynamic stop effect achieved by a magnet and a spring type automatic return on one and/or the other of the angular displacements of the handle of the mixer in a vertical plane.

From the point of view of the user, the tap mixer according to the invention makes it possible to adjust the flow of a mixture of liquids by a lever orientable at constant angle around a vertical direction to vary the liquid content of the mixture and capable of pivoting in a vertical plane in an angular range between a minimum and a maximum, to vary the flow of the mixture, and has a flow stop position within said angular range with a non zero flow both on one side and the other of this position.

The invention is capable of industrial application in the field of the manufacture of mixer taps, in order to provide said mixer taps with an additional liquid mixture flow mode without modification of the amplitude of the travel of their lever.

1. A mixer tap to discharge a mixture of liquids, comprising:
a moving plate mixing system provided with a mixing channel, moving in translation on a fixed plate provided with orifices for the inlet of liquids and the outlet of a mixture of said liquids after passing through the mixing channel;
a lever angularly orientable in a plane between an angular minimum and a maximum, wherein the lever is configured to vary the flow of the mixture,
the lever being capable of pivoting, at constant angular orientation, around one direction of the plane, forming an axis of rotation for a moving cylinder in a fixed tap body, the cylinder being linked to the lever in the movement, to vary the liquid content of the mixture;
first means of discharging the mixture, by initially orienting the lever on a first side of a stop position and stopping the flow of mixture by subsequently orienting the lever in a vicinity of the stop position;
second means of discharging the mixture by orienting the lever on a second side of the stop position; and
a dynamic stop felt by a user pressing on the lever, when the lever passes through the stop position.

2. The mixer tap according to claim 1, wherein the dynamic stop comprises means of returning the lever to the vicinity of the stop position, when not pressed by the user, for positions of the lever on the second side of the stop position, said return means being inactive during the positioning of the lever on the first side of the stop position, while moving away from the stop position.

3. The mixer tap according to claim 2, wherein the first means enable, by orienting the lever on the first side of the stop position, the rotation in a direction of an intermediate part, linking said lever to said moving plate, to control said translation of the moving plate on said fixed plate, the translation controlling said flow of the mixture, and wherein the second means enable, by orienting the lever on the second side of the stop position, the orientation of the intermediate part in a same direction.

4. The mixer tap according to claim 1, wherein:
the first means comprise, in said plate moving in translation on said fixed plate:
a first hollow channel, wherein the first hollow channel enables the flow of the mixture for the orientations of said lever on the first side of the stop position, and
a solid zone to stop the flow of mixture at the stop position; and
the second means comprise, in the plate moving in translation on the fixed plate:
a second hollow channel connected to the first hollow channel, enabling the flow of mixture for orientations on the second side of the stop position.

5. The mixer tap according to claim 1, wherein:
the first means comprise:
a first liquid circuit comprising a first liquid inlet pipe and a second liquid mixture outlet pipe, the flow of mixture between the pipes being controlled by the orientation of the lever on the first side of the stop position and stopped at the position of the first side,
the second means comprise:
a second liquid circuit comprising a first liquid inlet tube and a second liquid mixture outlet tube, the flow between the tubes being controlled by the orientation of the lever on the second side of the stop position, controlling a solenoid valve separating the first and the second tube, and
wherein the second pipe and the second tube are connected together.

6. The mixer tap according to claim 1, wherein the first means comprise, in said moving plate, a groove to receive a pin integral with the lever, the lever being movable in rotation around an axis, the displacement of the pin in the groove controlling the translation of the plate in a direction and the flow of mixture for orientations of the lever on the first side of the stop position, and stopping the flow at the stop position, and wherein the second means comprise an extension of the groove to conserve the same direction of translation of the moving plate by orientation of the lever on the second side of the stop position.

7. The mixer tap according to claim 3, wherein the first means comprise a gear assembly common to the intermediate part and the lever, orienting the intermediate part in rotation in one direction when the lever is oriented on the first side of the stop position, and wherein the second means are constituted by a flat spot common to the intermediate part and the lever, orienting the intermediate part in rotation in the one same said direction when the lever is oriented on the second side of the stop position, wherein the lever is movable around a first axis, the intermediate part is movable around a second axis, and the first axis is displaced by guiding means on a circular trajectory centered on the second axis for orientations of the lever on the second side of the stop position.

8. The mixer tap according to claim 3, wherein the first means comprise a groove in the intermediate part to receive a pin integral with the lever, wherein the lever is movable in rotation around a first axis and the intermediate part is movable around a second axis, the displacement of the pin in the groove inducing the rotation of the intermediate part in one direction, when the lever is oriented on the first side of the stop position, and wherein the second means comprise an extension of the groove in the intermediate part, the displacement of the pin inducing the rotation of the intermediate part in the one direction, when the lever is oriented on the second side of the stop position.

9. The mixer tap according to claim 3, wherein the first and the second means comprise:
a connecting rod linking the lever and the intermediate part,
wherein the connecting rod is movable along a primary axis of rotation around the lever and along a secondary axis around the intermediate part,
wherein the lever is movable in rotation around a first axis and the intermediate part is movable around a second axis, the first and second axes being parallel to each other,
wherein the stop position is defined by the orthogonality of the plane of the primary and secondary axes and the plane of the secondary and second axes, the rotation of the intermediate part taking place, by means of the connecting rod, in a same direction for an orientation of the lever on the first side and on the second side of the stop position.

10. The mixer tap according to claim 3, wherein:
the first means comprise:
a first axis for the rotation of the intermediate part,
a circular groove, formed in the lever and centered on said first axis,
a pin integral with said cylinder, arranged in the groove, said pin bearing on a first end of the groove at the stop position of the lever and beyond, and the pin being displaced in the groove for positions of the lever on the first side of the stop position, to assure an orientation of the lever in rotation around the first axis on the first side of the stop position and around the pin on the second side, and
a first blocking lug, formed in the lever, immobilising the intermediate part in relation to the lever for its positions on the first side of the stop position, when the lever is moved away from the stop position, to induce the rotation of the intermediate part in one direction,
second means comprise:
a second lug, formed on the lever, arranged between the first axis and the pin, the rotation of the lever around the pin in an opposite direction for orientations of the lever on the the second side of the stop position, controlling the rotation of the intermediate part in the same direction, by said second lug bearing on this intermediate part,
wherein the return means are arranged between the intermediate part and the lever.
